(19) United States
(12) Patent Application Publication
(10) Pub. No.: US 2010/0167243 A1
(43) Pub. Date: Jul. 1, 2010

(54) SYSTEM AND METHOD FOR AUTOMATIC CONSTRUCTION OF REALISTIC LOOKING TOOTH ROOTS

(76) Inventors: Anton Spiridonov, Moscow (RU); Alexander Pimenov, Moscow (RU)

Correspondence Address: Theodore P. Lopez;Klein, O'Neill & Singh, LLP, Suite 204, 43 Corporate Park, Irvine, CA, 92606, US

(21) Appl. No.: 12/347,291

(22) Filed: Dec. 31, 2008

(51) Int. Cl. A61C 5/02

(52) U.S. Cl. 433/224

(57) ABSTRACT

A system and computer-implemented method including generating a patient digital tooth model including a crown component; generating landmarks on an edge of the crown component; and generating a generic digital tooth model corresponding to the patient digital tooth model. The generic digital tooth model including both root and crown components. The method also includes mapping the landmarks on the edge of the crown component on to the generic digital tooth model; solving a first morphing function to fix landmarks on an edge of the crown component to a ring-edge space; solving a second morphing function to fix landmarks on the generic digital tooth model to ring-edge space; and selecting vertices in ring-edge space to stitch tooth crown with morphed template root.

### BACKGROUND

1. Field of the Invention

The present invention relates, generally, to dental and/or orthodontic treatment, and in particular to a system and method for modeling realistic looking tooth roots of a patient to facilitate dental and/or orthodontic treatment.

2. Related Art

The ability to provide an accurate and complete modeling of teeth is an important element in the growing field of computational orthodontics and other computer aided dental treatment systems. Many techniques for impression-based computational orthodontics are limited to crown modeling of the patient's tooth, such as the capturing of crown and gum shape information. Many impression techniques do not capture or use corresponding root information. As a result, such impression techniques do not provide for the root component within the present tooth model, and often fail to account for root movement and/or interaction within the gums, thus limiting the ability of the complete tooth model in facilitating orthodontic treatment. Such failure to account for root movement can also result in root collision that hinders the orthodontic treatment process.

### SUMMARY

In accordance with various aspects of the present invention, a system and method for three-dimensional modeling of a complete tooth and/or teeth, including both root and crown, of a patient to facilitate dental and/or orthodontic treatment are provided.

In one aspect, a system and computer-implemented method for modeling realistic looking tooth roots of a patient is provided to facilitate dental and/or orthodontic treatment. The computer-implemented method for modeling includes generating a patient digital tooth model including a crown component; generating landmarks on an edge of the crown component; and generating a generic digital tooth model corresponding to the patient digital tooth model. The generic digital tooth model including both root and crown components. The method also includes mapping the landmarks on the edge of the crown component on to the generic digital tooth model; solving a first morphing function to fix landmarks on an edge of the crown component to a ring-edge space; solving a second morphing function to fix landmarks on the generic digital tooth model to ring-edge space; and selecting vertices in ring-edge space to stitch tooth crown with morphed template root.

Such a process may be suitably applied for any and all of the various teeth within a patient, such as molars, bicuspids, canines or any other teeth within a patient. Various exemplary embodiments may comprise methods and systems for automated generation of morphing landmarks, model segmentation, root and crown stitching and/or three-dimensional root model adjustment. Such modeling techniques may be conducted with one or more computer-based systems, such as systems configured for storing actual patient data and generic tooth data, morphing generic tooth data to such patient's data and/or facilitating additional orthodontic treatment applications, through the use of one or more algorithms.

This brief summary has been provided so that the nature of the invention may, be understood quickly. A more complete understanding of the invention may be obtained by reference to the following detailed description in connection with the attached drawings.

### BRIEF DESCRIPTION OF THE DRAWINGS

The foregoing features and other features of the present invention will now be described with reference to the drawings. In the drawings, the same components have the same reference numerals. The illustrated embodiment is intended to illustrate, but not to limit the invention. The drawings include the following Figures:

FIG. 1A is a flow diagram of a system for modeling tooth root and crown in accordance with an embodiment of the present invention;

FIG. 1B is a flow diagram illustrating a system in accordance with an embodiment of the present invention;

FIG. 1C is an illustration of the input, output and usage of the modeling system of FIG. 1A in accordance with an embodiment of the present invention;

FIG. 2 illustrates an exemplary computer-implemented method for modeling of tooth root and crown of a patient in accordance with an embodiment of the present invention;

FIG. 3A is a flow diagram of a process for generating a generic tooth model template in accordance with an embodiment of the present invention;

FIG. 3B is an illustration of a generic tooth model template in accordance with an embodiment of the present invention;

FIGS. 4A-4I are illustrations of a technique for generating landmarks in accordance with an embodiment of the present invention;

FIGS. 5A and 5B are illustrations for implementing a process of automated crown/root mesh generation in accordance with an embodiment of the present invention;

FIGS. 6A-6B are illustrations of a technique for mapping landmarks on a tooth template in accordance with an embodiment of the present invention;

FIG. 7 is an illustration of a technique for fixing landmarks on a ring-edge space in accordance with an embodiment of the present invention;

FIG. 8 is an illustration of a technique for selection of root or crown in ring-edge space in accordance,with an embodiment of the present invention;

FIGS. 9A-9F are illustrations of a technique for stitching a crown mesh and a root mesh in ring-edge space in accordance with an embodiment of the present invention;

FIG. 10 is an illustration of a technique for stitching in a tooth space in accordance with an embodiment of the present invention; and

FIGS. 11A-11F include a flow chart and supporting illustrations of a method for detailed adjustment modeling in accordance with an embodiment of the present invention.

### DETAILED DESCRIPTION

The present invention may be described herein in terms of various components and processing steps. It should be appreciated that such components and steps may be realized by any number of hardware and software components configured to perform the specified functions. For example, the present invention may employ various electronic control devices, visual display devices, input terminals and the like, which may carry out a variety of functions under the control of one or more control systems, microprocessors or other control devices.

In addition, the present invention may be practiced in any number of orthodontic or dental contexts and the exemplary embodiments relating to a system and method for modeling of complete tooth of a patient as described herein are merely a few of the exemplary applications for the invention. For example, the principles, features and methods discussed may be applied to any orthodontic or dental treatment application or process.

For illustrative purposes, the various exemplary methods and systems may be described in connection with a single tooth of a patient; however, such exemplary methods and systems may be implemented on more than one tooth and/or all teeth within a patient, such as molars, bicuspids, canines, incisors or any other teeth. For example, the exemplary methods and systems may be implemented by performing a particular process, operation or step on one or more teeth before proceeding to a subsequent process, operation or step, or by performing all or essentially all processes, operations or steps on a particular tooth before proceeding to another tooth, or any combination thereof.

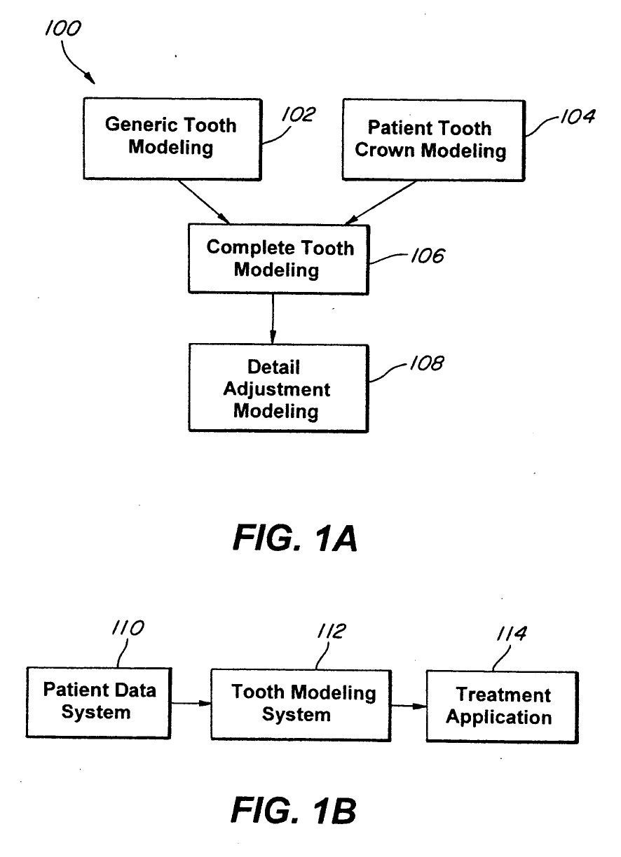

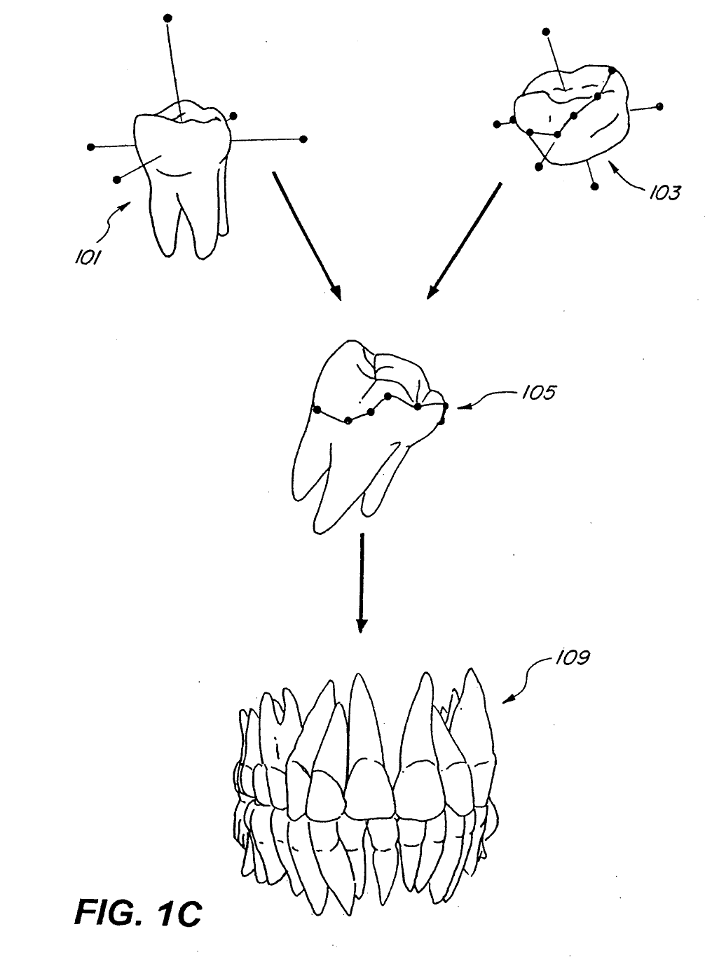

With reference to FIGS. 1A-1C, in accordance with an exemplary embodiment, a system for modeling tooth root and crown 100 includes a generic tooth three-dimensional modeling module 102 for yielding an exemplary tooth 101 configured for combination with a three-dimensional model 103 of a patient's crown from patient tooth crown modeling module 104 for the corresponding tooth to yield a complete three-dimensional model 105 in complete tooth modeling module 106 for that particular tooth.

Generic tooth modeling module 102 is configured to provide a generic three-dimensional model of both root and crown for a particular tooth of a patient, such as generic tooth model 101. In one embodiment, generic tooth model 101 may be of the same type of tooth (e.g. molar, canine, bicuspid and the like) as the actual tooth it is intended to model. Moreover, in other exemplary embodiments, generic tooth model 101 may be the same numbered tooth as the actual patient tooth, using conventional tooth numbering and identification systems.

Patient tooth crown model 103 may be suitably generated in patient tooth crown modeling module 104 by various techniques known for tooth crown modeling used to generate a three-dimensional patient tooth crown. The techniques may include, for example, those disclosed in U.S. Pat. No. 6,685,469, assigned to Align Technology, Inc. (the “'469 Patent”), or such modeling processes known and provided under the brands INVISALIGN® and CLINCHECK® that are available from Align Technology, Inc. of Santa Clara, Calif.

The creation of complete tooth model 105 may be suitably realized by an automated morphing/stitching of generic tooth model 101 and patient tooth crown model 103, such as by a computer algorithm within complete tooth modeling module 106, with such processes being applied to any or all teeth within the patient.

As shown in FIG. 1B, the exemplary modeling methods may be conducted with one or more computer-based systems, such as a patient data system 110 configured for storing patient data and generic tooth data, and a tooth modeling system 112 configured for generating generic tooth model 101 and patient tooth crown model 103 and for morphing data and information from model 101 and model 103 to generate complete tooth model 105. A system 114 may be configured for facilitating any other conventional orthodontic treatment applications, such as methods or processes for tracking teeth movement and position, evaluating gingival effects, or any other orthodontic treatment process from pretreatment to final stages, or any stages in between.

Systems 110, 112 and/or 114 may include one or more microprocessors, memory systems and/or input/output devices for processing modeling data and information. To facilitate modeling of root and crown of a patient, tooth modeling system 112 may include one or more software algorithms configured for generating complete tooth model 105 and/or performing other functions set forth herein.

In accordance with an exemplary embodiment, further adjustment of the complete tooth model for the tooth may be provided through a transition or smoothing modeling module 108 described in further detail below.

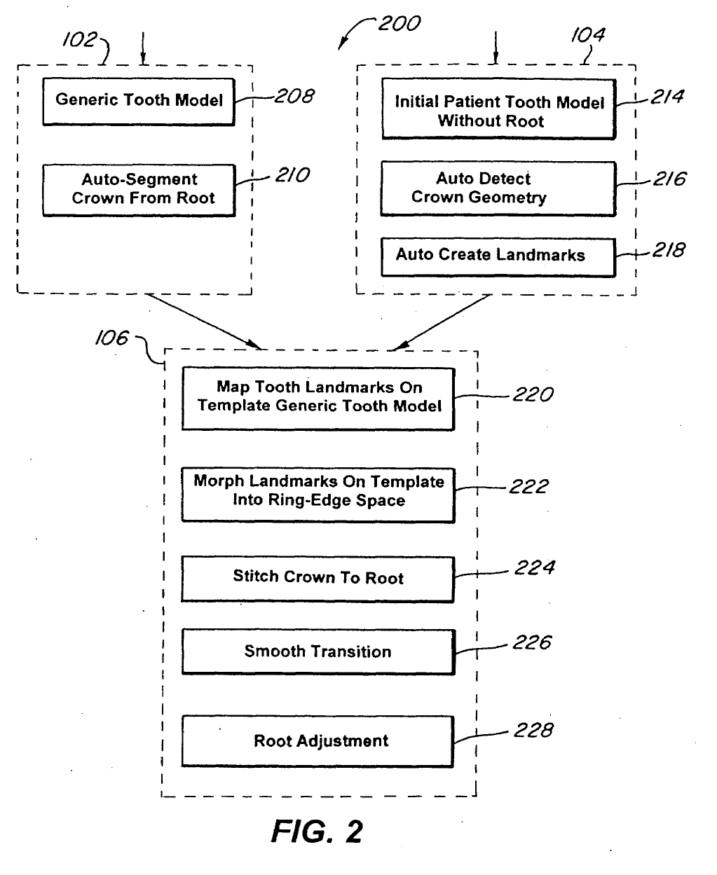

FIG. 2 illustrates an exemplary computer-implemented method 200 for modeling of tooth root and crown of a patient. Method 200 includes generic tooth modeling module 102, patient tooth crown modeling module 104, and complete tooth modeling module 206 which act to combine the morphed generic root model 101 with the corresponding patient tooth crown model 103. Method 200 may be used to provide both generic tooth models and crown tooth models for each tooth of a patient, thus enabling a complete tooth model for any and/or all teeth of a patient to be obtained for facilitating orthodontic treatment.

As shown in FIG. 2, generic tooth modeling module 102 may be configured to provide a reference for construction for complete tooth modeling, such as the generation of generic tooth 101 (FIG. 1C) including both root and crown components for a particular tooth. In accordance with an exemplary embodiment, generic tooth modeling module 102 includes the generation of a generic tooth model template (208) and auto-segmenting of a generic crown from the generic root within the generic tooth model (210).

Generation of a generic tooth model template (208) may be configured to facilitate the creation of landmarks on the generic tooth model to allow for morphing with the patient tooth crown model. For example, in order to generate adequately distributed landmarks and to accurately segment the crown from the tooth, the setup of generic teeth data is provided to generate a generic tooth template.

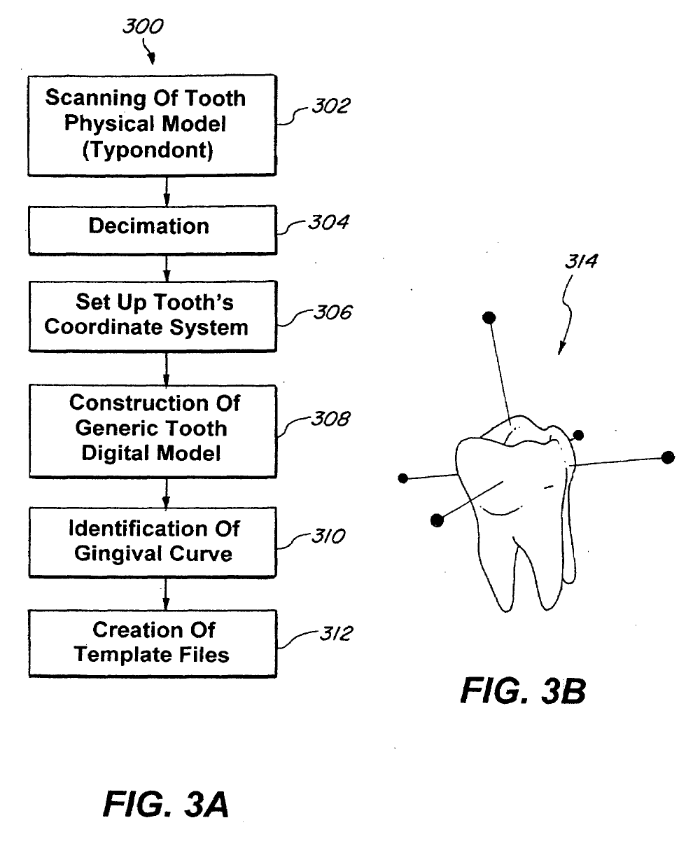

With reference to a flow diagram illustrated in FIG. 3A, in accordance with an exemplary embodiment, a process 300 for generating of a generic tooth model template (208) includes the acquisition of data from a physical tooth model (302), the decimating of tooth model data (304), the setting up a generic tooth coordinate system (306), the constructing of a generic tooth digital model (308), the identifying of gingival curves (310) and the creating of template file(s) associated with the generic teeth (312). The acquisition of data from a physical tooth model data (302) may include the scanning of a standard typodont or any other three-dimensional models for demonstrating alignment of teeth within a patient to generate three-dimensional digital template data.

Such typodont or models that are used for scanning may include both an exemplary root and crown for a single tooth or multiple teeth of a patient. In addition, such typodont or generic models may be provided based on different configurations of teeth, e.g., different sizes, shapes, and/or caps, different types of teeth such as molars, bicuspids or canines, and/or different occlusal patterns or characteristics, e.g., overbite, underbite, skewed or other like misalignment patterns.

In accordance with an exemplary embodiment, the root shape, configuration or component for such typodont models may include the same generic root configuration for all types of teeth. In accordance with other exemplary embodiments, the root component for such typodont models may include a typical generic root configuration for a type of tooth, e.g., a typical root shape or configuration for molars, bicuspids and/or canines may be provided, based on one type for all patients, or based on whether the patient is a child or adult, male or female, or any other demographic or characteristic that might be associated with different types of teeth. Moreover, in accordance with other exemplary embodiments, the root component for such typodont models may include a typical generic root shape or configuration for a specific actual tooth, e.g., a specific root shape for a particular canine tooth may he used with the specific crown shape for that particular canine tooth to generate the typodont model, again based on one configuration for that particular tooth all patients, or based on different configurations for that specific tooth depending on whether the patient is a child or adult, male or female, or any other demographic or characteristic that might be associated with different types of teeth.

As such, generic models for any type of teeth characteristic or type may be provided and used, allowing great flexibility in specializing for different teeth structures, occlusal patterns and characteristics of a patient. In addition, any conventional devices, systems and/or methods for the scanning of physical models, such as typodonts, to generate data may be used, such as known techniques for generating initial digital data sets (IDDS), including that set forth in U.S. Pat. No. 6,217,325, assigned to Align Technology, Inc.

To reduce the amount of data and/or filter out any undesirable data after such acquisition of data from the typodont or generic tooth model, the decimating of data (304) may be conducted, such as the removal or deletion of data or otherwise the finding of optimal data values through the elimination at a constant fraction of the scanning data; however, the decimating of data (304) can also be omitted or otherwise replaced by any filtering or data enhancement techniques.

Whether or not the scanned data is decimated, the developing of a generic tooth coordinate system (306) may be undertaken, such as to setup or develop a generic tooth coordinate system for generic tooth template 314 (FIG. 3B). The coordinate system may be set-up automatically and/or adjusted manually, using any conventional or later developed techniques for setting up coordinate systems of an object. Upon generation of a coordinate system for a generic tooth, the constructing of a digital generic tooth model (308) including root and crown may be conducted for an individual tooth and/or two or more teeth. Such construction of digital tooth models may include any methodology or process for converting scanned data into a digital representation. Such methodology or processes can include, for example, those disclosed in U.S. Pat. No. 5,975,893, entitled “Method and System for Incrementally Moving Teeth” assigned to Align Technology, Inc. For example, with reference to an overall method for producing the incremental position adjustment appliances for subsequent use by a patient to reposition the patient's teeth as set forth in U.S. Pat. No. 5,975,893, as a first step, a digital data set representing an initial tooth arrangement is obtained, referred to as the IDDS. Such an IDDS may be obtained in a variety of ways. For example, the patient's teeth may be scanned or imaged using well known technology, such as X-rays, three-dimensional x-rays, computer-aided tomographic images or data sets, magnetic resonance images and the like.

Methods for digitizing such conventional images to produce data sets are well known, and described in the patent and medical literature. By way of example, one approach is to first obtain a plaster cast of the patient's teeth by well known techniques, such as those described in Graber, Orthodontics: Principle and Practice, Second Edition, Saunders, Pa., 1969, pp. 401-415. After the tooth casting is obtained, it may be digitally scanned using a conventional laser scanner or other range acquisition system to produce the IDDS. The data set produced by the range acquisition system may, of course, be converted to other formats to be compatible with the software which is used for manipulating images within the data set. General techniques for producing plaster casts of teeth and generating digital models using laser scanning techniques are described, for example, in U.S. Pat. No. 5,605,459.

After construction of the generic tooth digital model (308), the identifying of the gingival curve (310) may be conducted to identify the gum lines and/or root association. Such identification may include any conventional computational orthodontics methodology or process for identification of gingival curves, now known or hereinafter derived. For example, the methodologies and processes for identification of gingival curves can include those disclosed in U.S. Pat. No. 7,040,896, entitled “Systems and Methods for Removing Gingiva From Computer Tooth Models”, and assigned to Align Technology, Inc. (the “'896 Patent”) and U.S. Pat. No. 6,514,074, entitled “Digitally Modeling the Deformation of Gingival”, and assigned to Align Technology, Inc. (the “'074 Patent”), and the various patents disclosed in the '896 and '074 Patents. In the '896 Patent, for example, such a process for identification of gingival curves may include a computer-implemented method separates a tooth from an adjacent structure, such as a gingiva, by defining a cutting surface, and applying the cutting surface between the tooth and the structure to separate the tooth in a single cut. In the '074 Patent, for example, such a process for identification of gingival curves may include having a computer obtain a digital model of a patient's dentition, including a dental model representing the patient's teeth at a set of initial positions and a gingival model representing gum tissue surrounding the teeth, where the computer then derives from the digital model an expected deformation of the gum tissue as the teeth move from the initial positions to another set of positions.

Having constructed the digital generic tooth model (308) and identified the gingival curve (310), one or more generic tooth template files may be created (312), such as the exemplary generic tooth template 314 illustrated in FIG. 3B. Such a generic tooth templates may then be used to allow for segmenting of crowns and landmark distribution on the generic tooth. In addition, such generic teeth templates may be used for one or more treatments, and/or replaced or updated with other generic teeth templates as desired. Moreover, such generic teeth templates may be created and/or stored for later use, and may be configured for various differences in patients, such as for children-based templates and adult-based templates, with the ability to have a plurality of templates that are specially created for the different types of teeth and related characteristics, sizes, shapes, and occlusal patterns or other features.

Referring again to FIG. 2, after generic teeth templates have been generated, automated segmenting of a generic crown from the generic root within the generic tooth template (210) may be conducted to prepare the generic tooth template for landmark mapping. In this process, the crown portion of the generic tooth template is suitably parceled out and/or identified to allow mapping during landmark mapping processes.

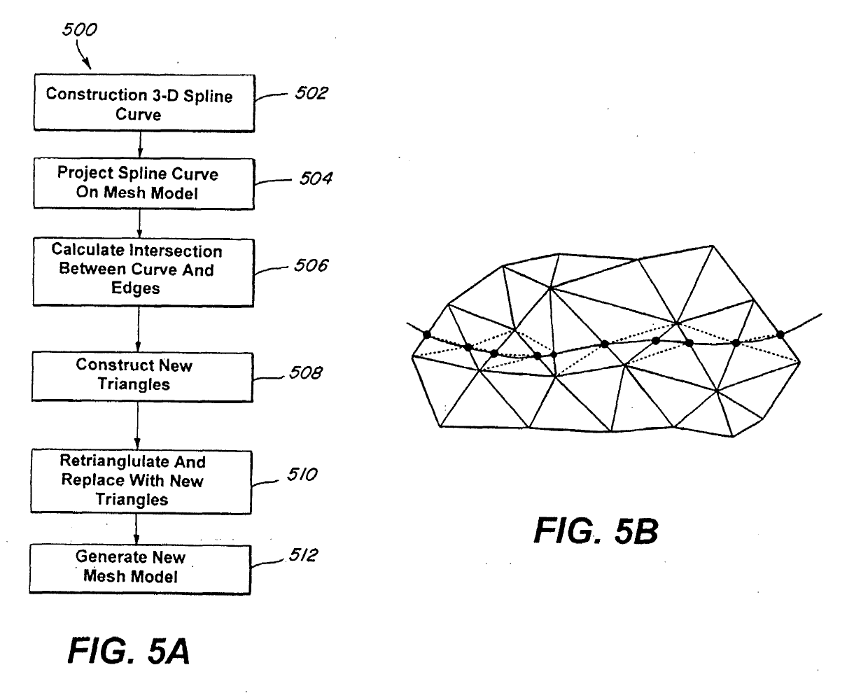

For the generic tooth model, the crown and root geometry may be extracted from the generic tooth model. After such extraction or segmentation, the crown/root mesh may be generated. For example, with reference to FIGS. 5A and 5B, a process 500 for automated crown/root mesh generation may include the construction of the 3D spline curve (502), wherein control points on the transition area between the tooth crown and root are used, such as that illustrated in FIG. 5B. Next, the projection of the 3D spline curve on the tooth mesh model (504) may be conducted. A calculation of the intersection between the projected curve and the edges of triangle faces of the mesh (506) can then be made to facilitate the construction of new triangles (508). In this process, the three original vertices of the intersected triangle and the two intersection points may be used to construct three new triangles, such as by use of the Delaunay triangulation's max-min angle criterion. After such construction, the re-triangulation of the old intersected triangle and replacing that old triangle with the three-newly generated triangles (510) may be conducted. Upon re-triangulation and replacement, the generation of new crown/root mesh model (512) may be realized by removing all the faces below/above the projected curve, resulting in a segmented generic tooth crown/root. Processes 502, 504, 506, 508, 510 and 510 may be provided through any known conventional techniques for providing such functions, or hereinafter devised.

Referring again to FIG. 2, method 104 for generating a patient tooth crown model 103 may include the generation of an initial patient tooth model without root (214), which means generation of a crown tooth model, automated detection of the crown geometry (216) and the automated creation of landmarks on the patient crown tooth model (218).

Generating the crown tooth model (214) may be realized by various known methods and techniques, including various conventional scanning techniques used in computational orthodontics for creating IDDS and the like. For example, such an IDDS may be derived from the above methods and/or as set forth in U.S. Pat. No. 6,217,325, also assigned to Align Technology, Inc. In an exemplary embodiment, to obtain an IDDS, the patient's teeth may be scanned or imaged using well known technology, such as X-rays, three-dimensional X-rays, computer-aided tomographic images or data sets, magnetic resonance images, etc. Methods for digitizing such conventional images to produce data sets useful in the present invention are well known and described in the patent and medical literature. Usually, however, an IDDS procurement will rely on first obtaining a plaster cast of the patient's teeth by well known techniques, such as those described in Graber, Orthodontics: Principle and Practice, Second Edition, Saunders, Pa., 1969, pp. 401-415. After the tooth casting is obtained, it may be digitally scanned using a conventional laser scanner or other range acquisition system to produce the IDDS. The data set produced by the range acquisition system may, of course, be converted to other formats to be compatible with the software which is used for manipulating images within the data set, as described in more detail in U.S. Pat. No. 6,217,325. General techniques for producing plaster casts of teeth and generating digital models using laser scanning techniques are described, for example, in U.S. Pat. No. 5,605,459.

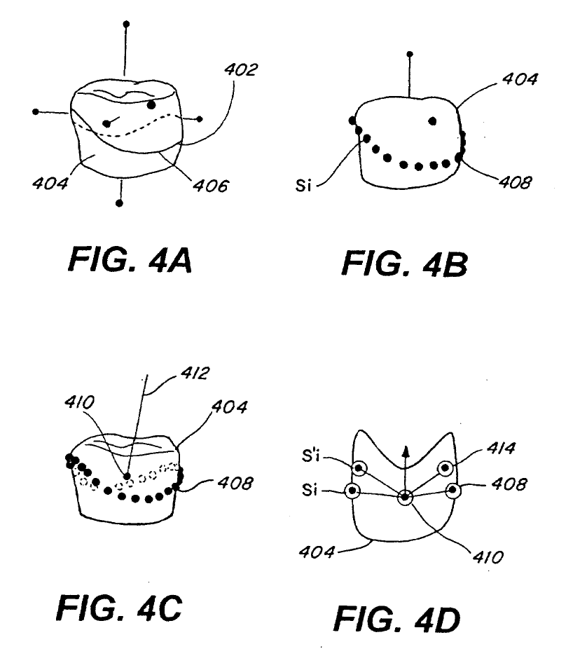

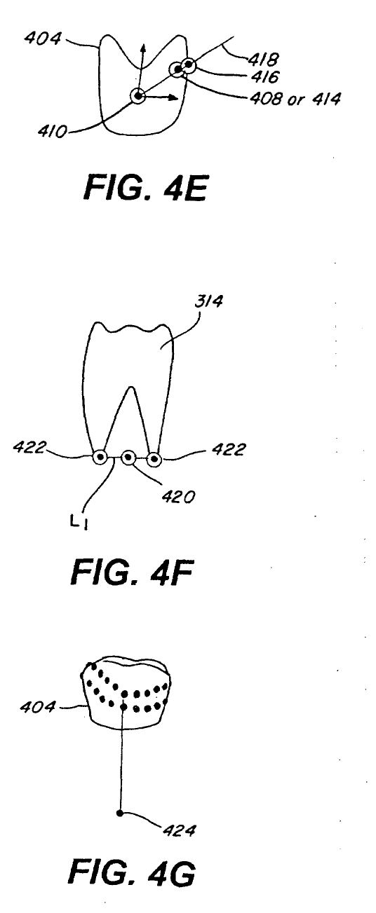

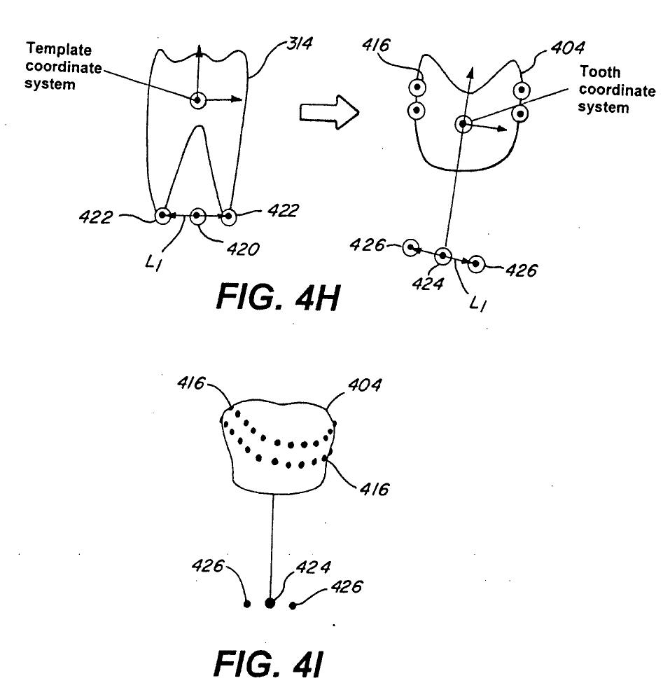

Upon generating the crown tooth model, automatic detection of the crown geometry (216), including the edge, is conducted to prepare the tooth model for creation of landmarks. Upon detecting the crown geometry, the automated creation of landmarks (218) on the patient crown tooth model may be provided using the technique illustrated by FIGS. 4A-4I.

For application purposes generated landmarks may be made to satisfy the following:

1) Define transition of stitching line (crown edge).

2) Define normal vector at the stitching line (for smooth connection).

3) Define transition of root apes.

In one embodiment, therefore 3 series of landmarks are generated on each patient tooth, template and ring-edge space as described in detail below.

1) On a stitching line.

2) On a line parallel to stitching line and slightly moved off the cut surface. (Generation of this line is clarified below).

3) One at each apex.

As shown in FIG. 4A, on input, the edge 402 of tooth crown 404 is defined using a closed curve 406. As shown in FIG. 4B, closed curve 406 is split in several equal parts over its length with split points (Sᵢ) 408.

Next, as illustrated in FIG. 4C, a middle point (M_{O})) 410 of closed curve 406 is calculated using:

$${M}_{0} = \frac{1}{N} {\sum }^{ } {s}_{i}$$

where N is the number of points. The rotation vector (R) 412 of the middle point 410 may then be calculated.

Next, each split point Sᵢ is modified into modified split points (Sᵢ′) 414 according to the following rule:

$${s}_{i} = ( 1 - Δ ) {s}_{i} + Δ ( {M}_{o} + \frac{d \vert {s}_{i} - {M}_{0} \vert \overline{R}}{\vert \overline{R} \vert} )$$

This is fast and similar to small rotation around center point 410 up to rotation vector 412. The result of the movement of points Sᵢ is shown in FIG. 4D where Sᵢ (408) are the original positions of the points while Sᵢ′ (414) are their positions after the movement.

As shown in FIG. 4E, each original and modified split point 408 and 414 becomes a landmark 416 of a first (408) and second (414) crown landmark series after projecting to a tooth edge using a projection line or ray 418. The rays 418 has its origin in the point middle point (M_{O}) 410 and directed towards points 408 and 414

As shown in FIG. 4F, the center of mass point 420 is determined for apex ends 497 on template 314. In addition, an offset L₁ may be determined, which is the distance from center of mass point 420 and the apex ends 422.

As shown in FIG. 4G, a point 424 is determined, which is expected to be a center of mass of tooth apex ends 426 for the patient tooth crown 404. The predicted center of mass point 424 may be determined using various methods. For example, in one embodiment, point 424 may be defined with coordinates [0, 0, −RootLength], where RootLength is a predefined constant for each class of orthodontic tooth. In another embodiment, point 424 may be determined externally, for example, by automated collision avoidance (special extension to avoid collisions at initial tooth positions or during treatment stages usually put center to position [x, y, −RootLength]). Automated collision avoidance is an iterative process in which the position [x, y, −RootLength] is moved in the direction opposite to the direction towards the nearest collision with adjacent tooth.

As illustrated in FIG. 4H, since the offset L₁ of apex end points 422 from center of mass point 420 on template 314 is known in the template coordinate system, the same offset L₁ may be transformed into the tooth crown coordinate system and used to determine a predicted location of apex ends 426 with same offset L₁ from mass center 424 as on template 314. Thus, as shown in FIG. 4I all tooth landmarks 416, root landmarks 426 and the root center point 424 for tooth crown 404 are created. Thus landmarks on the template 314 are transformed into tooth coordinate system.

Upon generation of the generic tooth model (102) and the crown tooth model (104), generation of the complete tooth model (106) may be conducted through combination/morphing/stitching of the generic tooth model with the corresponding patient tooth crown model. In accordance with an exemplary embodiment, a method for generating a complete tooth model (106) may include mapping crown tooth landmarks on a template (220), fixing mapped landmarks in ring-edge space (222), stitching the patient crown to the patient root (224), smoothing the root-crown transition area (226) and conducting interactive adjustment of the patient root if necessary (228). Such processes may be completely conducted for individual teeth before proceeding to any other teeth, conducted concurrently, or any other combination thereof.

When beginning the processes (220) of mapping landmarks 416 and 426 to template 314, what is know is the vectors or rays 418 (see FIG. 4E) calculated for tooth crown 404, and also the location of apex end points 422 fixed on template 314. Rays 418 are transformed into template coordinate system and create projection lines or template rays 602 on template 314.

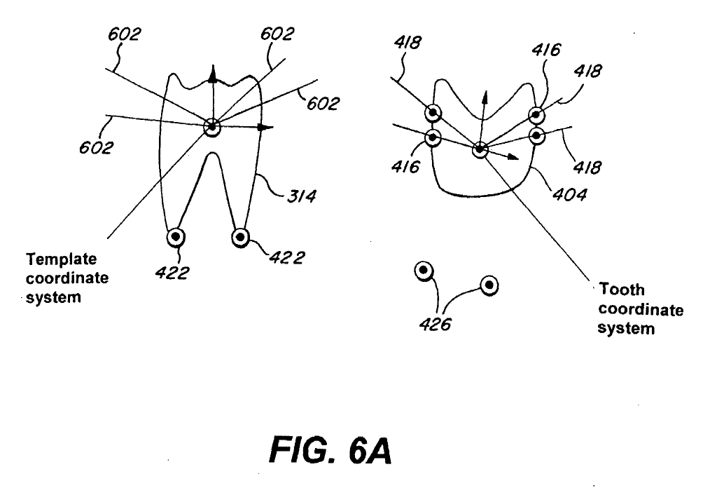

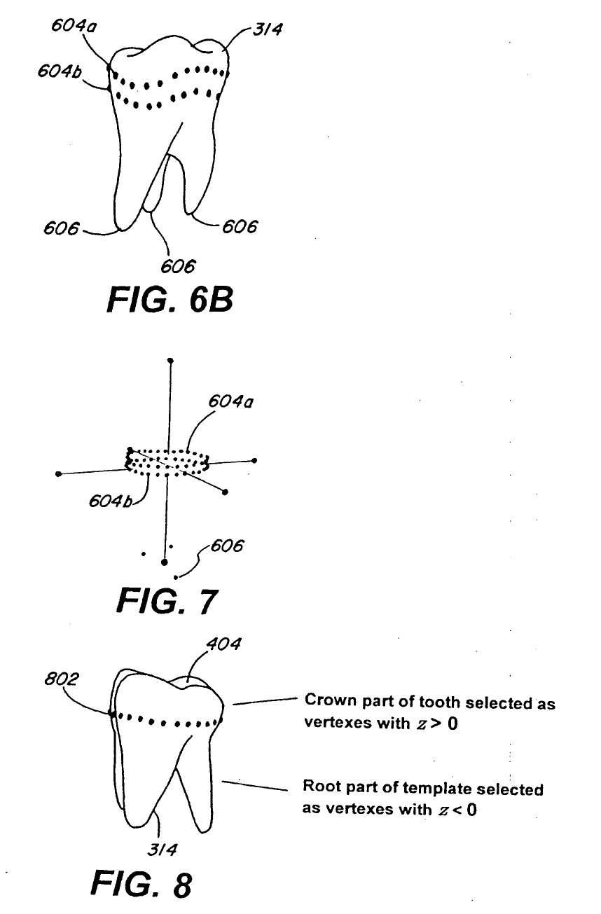

As shown in FIG. 6A, with tooth crown 404, all landmarks 416 and 426 may then be located on template 314 using the intersection of the edge of the template and rates 602. The intersection of template 314 with rays 602 defines the first and second crown landmark series (hereinafter, first series landmarks 604a and second series landmarks 604b) now on template 314 as well as root landmarks 606. Rays 418 are transformed into rays 602 using transform of the coordinate system of tooth 404 into template 314.

Once the mapping of landmarks on template 314 is complete (220), the first and second crown landmark series 604a and 604b and root landmarks 606 may be fixed or morphed into ring-edge space (222) (FIG. 2).

The ring-edge space is an artificial algebraic space where the boundary of the crown is a ring. First series of landmarks 604a are fixed on a ring in plane z=0 with a length equal to length of edge curve 406. Therefore:

$$R = \frac{{L}_{curve}}{2 π}$$

Second series of landmarks 604b are fixed on a ring in plane

$$z = \frac{R}{5}$$

with the same radius. Root landmarks 606 are transformed into the ring-edge space retaining their coordinates.

After this morphing both tooth crown 404 and template 314 have a crown edge 802 lying in an x, y plane with their centers in the zero of coordinates. Thus, as shown in FIG. 8, selection of root or crown in ring-edge space is a matter of checking whether vertex coordinate z is greater or less than zero.

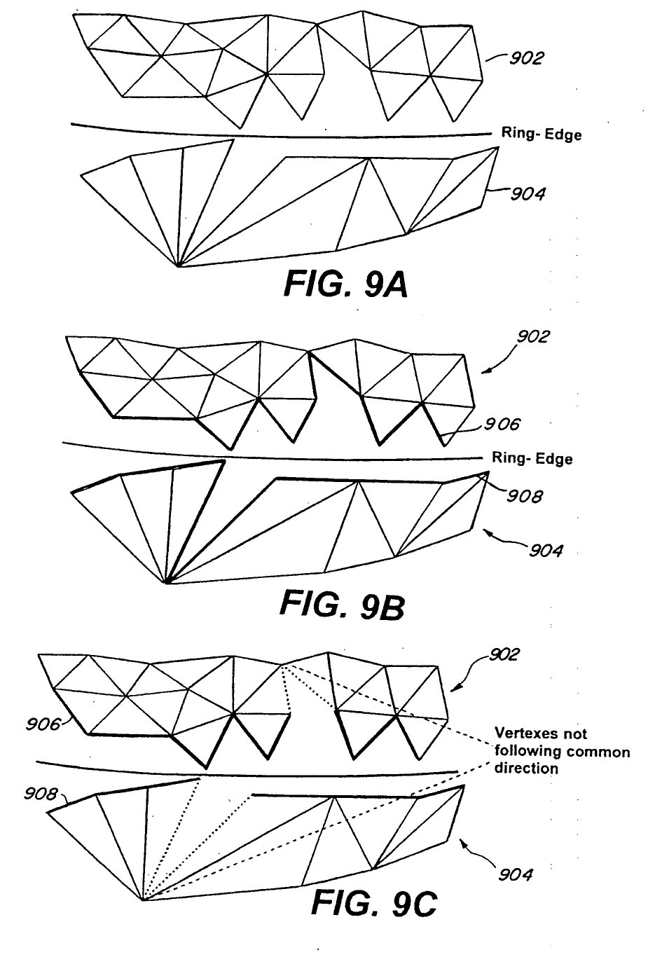

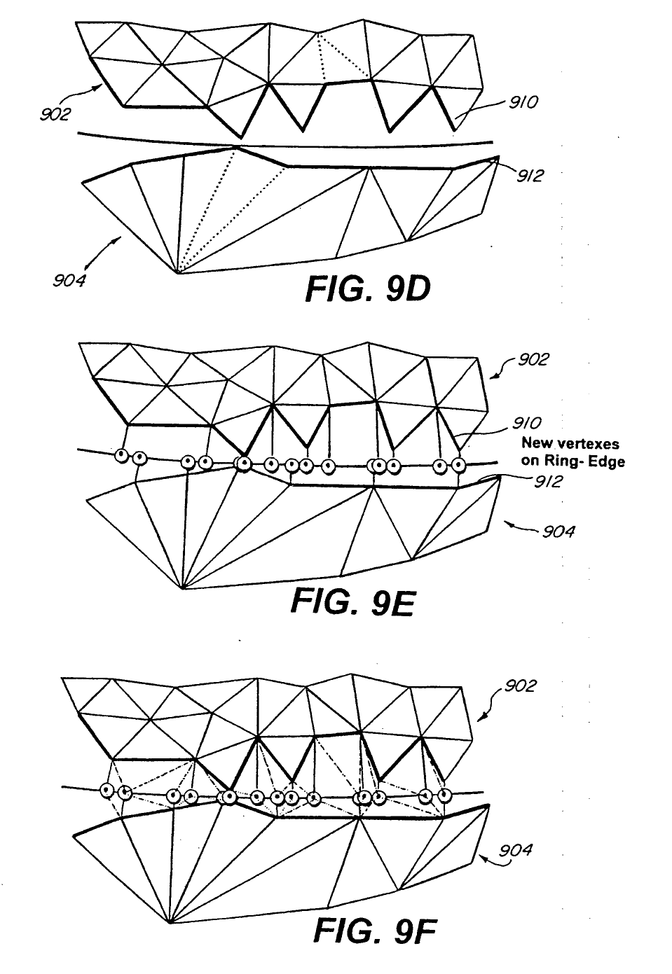

After morphing of the first and second crown landmark series 604a and 604b into ring-edge space (222), the patient crown is stitched to the patient root to generate the complete 3D tooth model (224). To facilitate stitching, the crown mesh 902 and the root mesh 904 are suitably merged. Operationally, stitching between crown 404 and the root is performed in the ring-edge space. For example, with reference to FIG. 9A, the stitching process may include the triangulation of crown part of the tooth and root part of the template in the ring-edge space. The meshes of crown 902 and root template 904 are cut across edges which cross the boundary of the crown using the condition z=0 thus forming meshes 902 and 904 (FIG. 9A).

Next, crown triangulation edge contours 906 and root triangulation edge contours 908 (hereinafter “boundary loops 906 and 908”) are determined and selected (FIG. 9B).

As shown in FIG. 9A, in each boundary loop 906 and 908, contours (with their vertexes) are selected which are directed counter-clockwise. Upon finding the contours, the vertexes order over ring edge are checked. It may be determined that some vertexes do not follow the common counter-clockwise direction (FIG. 9C).

As shown in FIG. 9D, blocks which are not following the common direction are filled, which creates a new crown edge 910 and a new root edge 912. Triangles are added onto the selected edges so that new crown edge 910 and new root edge 912 have uniform direction (FIG. 9D).

Next, as shown in FIG. 9E, projections of vertices (points) from the new edges 910 and 912 are made or projected on the ring edge. As shown in FIG. 9F, the projected points and the vertexes of edges 910 and 912 are then subjected to re-triangulation resulting in the formation of a connection (stitching) between crown mesh 902 and root mesh 904 to obtain a topologically correct complete tooth mesh.

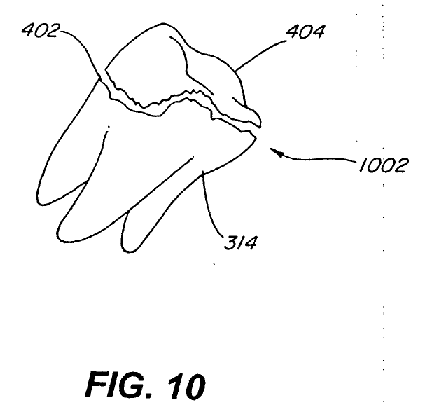

Next, the stitching in ring edge-space may be transformed into the tooth space to provide the tooth model 1062 (FIG. 10.). Initially, the information and results provided during stitching in ring-edge space and the information and results from transformations made from template to tooth (FIGS. 4A-4I) are used.

The transformation information is used to get template 314 tangent to tooth crown 404 at the crown edge 402. The same vertexes of tooth 404 and template 314 are maintained as in ring-edge space to arrive at the tooth model 1002 in FIG. 10. Next, vertexes, as they are generated in ring-edge space are added. Each vertex is connected to the same vertices of tooth 404 and modified template 314 as in ring edge space. The position of vertex is determined as a midpoint of all vertices it has edge to.

After stitching (224), the crown-root transition area of the complete tooth model may be suitably smoothed (226) to improve the model. For example, after the stitching process, the transition area may not be very smooth. However, through use of a suitably smoothing algorithm, the stitching may be suitably smoothed. In one embodiment, a smoothing algorithm operates as a filter to essentially remove “noise” from the stitched points within the transition area. For example, the algorithm may identify or target a first point, then observe neighboring points to suitably tweak or otherwise adjust the first point to smooth out the stitching. The algorithm may be suitably conducted for each tooth within the patient. Such an algorithm can also comprise various formats and structures for providing the smoothing function.

In one embodiment, after smoothing of the crown-root transition (226), interactive root adjustment (228) may be provided. The complete 3D root model may be adjusted by length or rotation on demand. For example, all the length of all roots, adjust all roots X-rotation, or the adjustment of one root. Such adjustment may be suitably carried out through a user interface, and/or automatically by the modeling system 112, to achieve a desired criteria. As a result, the complete tooth model is generated for use in facilitating treatment.

After generation of the complete tooth model 105, the generated root shape may vary from the actual root shape due to the individual features of the patient. With reference again to FIG. 1C in accordance with an exemplary embodiment, further adjustment of the complete tooth model for the tooth may be provided through detailed adjustment modeling 108. For example, additional patient root information regarding features or characteristics of the actual root, such as may be obtained from X-ray imaging information provided from a radiograph, may be used by tooth modeling system 112 to address the variations in root shape between a generic root and an actual root shape for a patient so as to yield a root shape on complete tooth model 105 which more closely approximates the actual root shape of the actual teeth.

Such additional actual root information may comprise various formats and generated in various manners. For example, X-ray imaging information may include, for example, panoramic, periapical, bitewing, cephalometric or other like information, for facilitating further detailed modeling. In addition, since such X-ray imaging information generally comprises a 2D image, the X-ray information may be considered approximately as a 2D projection from the facial side to the lingual side. As a result, the further detailed adjustment is based on one-view information, wherein the algorithm suitably makes the modeled root shape coincide with the actual root shape based on such one-view information.

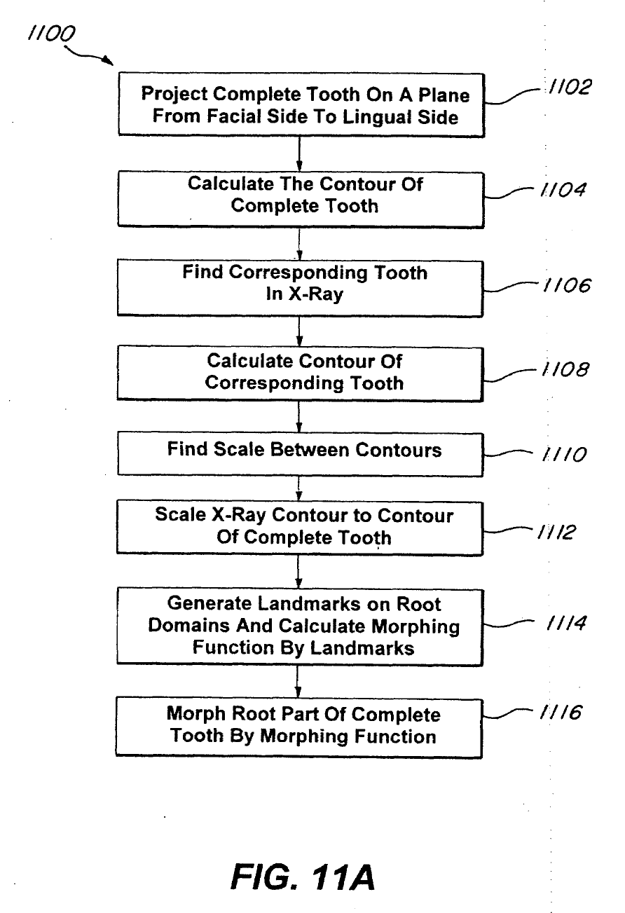

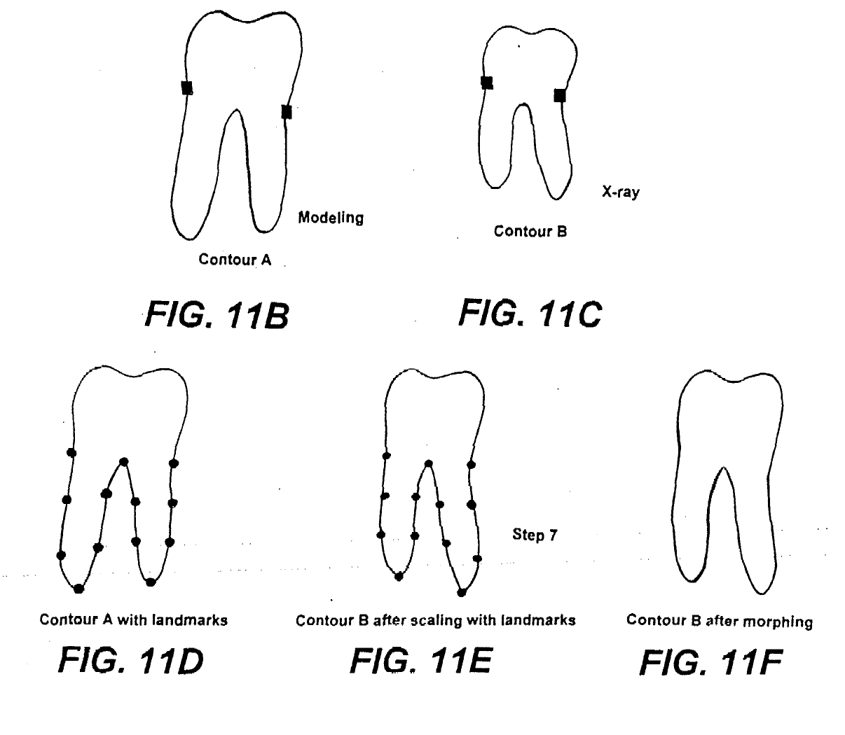

For example, with reference to FIG. 11A, a method for detailed adjustment modeling may begin with the projection of the complete tooth model, e.g., one derived after morphing/combination (106) of method 200, on a single plane, whose normal is from a tooth's facial side to a tooth's lingual side (1102). Next, the contour of the complete tooth may be calculated (1104) and defined, such as the tooth contour A illustrated in FIG. 11B. The corresponding patient tooth may be suitably identified from the X-ray information, such as from panoramic X-ray image (1106), and the contour of the corresponding tooth can also be calculated from that X-ray image (1108) and defined, such as the tooth contour B illustrated in FIG. 11C. Any conventional methodology or process for calculation and/or determination of contours may be readily utilized for determining the contours of tooth A and tooth B. Next, the scaling in size between the complete tooth contour (e.g., contour A), and the corresponding patient tooth contour (e.g., contour B) may be determined (1110), and then the corresponding patient tooth contour may be scaled to have to have the same crown contour as the complete tooth contour (1112). In accordance with another exemplary embodiment, instead of scaling complete tooth contour (1112), thin-plate spline based morphing function may be used to deform the corresponding patient tooth crown contour to the complete tooth crown contour. For example, the morphing function may be calculated by the landmarks on the corresponding patient tooth crown contour and complete tooth crown contour. Landmarks can then be generated (1114) on the root domain of the complete tooth contour (e.g., contour A), and the corresponding tooth contour (e.g., contour B), such as illustrated with reference to FIGS. 11D and 11E. Based on the generated landmarks, and the calculation of the morphing function, the complete tooth contour may be suitably morphed onto a projection plane (1116), such as illustrated in FIG. 11F. Such morphing may be conducted through similar processes as disclosed in morphing/combining process 206, e.g., by calculating a morphing function (220) and applying the morphing function of the root portion (222). Accordingly, a complete tooth model for any one and/or all teeth of a patient, suitably adjusted through an accounting of a patient's individual and/or specialized features and characteristics, may be realized.

The present invention has been described above with reference to various exemplary embodiments. However, those skilled in the art will recognize that changes and modifications may be made to the exemplary embodiments without departing from the scope of the present invention. For example, the various operational steps, as well as the components for carrying out the operational steps, may be implemented in alternate ways depending upon the particular application or in consideration of any number of cost functions associated with the operation of the system, for example, various of the component and methodologies and/or steps may be deleted, modified, or combined with other components, methodologies and/or steps.

Moreover, it is understood that various of the methods and steps disclosed herein, such as generating of IDDS, construction of 3D spline curves, identifying gingival curves or other processes may also include any other conventional techniques, or any later developed techniques, for facilitating such methods and steps. These and other functions, methods, changes or modifications are intended to be included within the scope of the present invention, as set forth in the following claims.

What is claimed is:

1. A computer-implemented method for modeling realistic looking tooth roots of a patient to facilitate dental and/or orthodontic treatment, said computer-implemented method for modeling comprising:
generating a patient digital tooth model including a crown component;
generating landmarks on an edge of said crown component;
generating a generic digital tooth model corresponding to said patient digital tooth model, said generic digital tooth model including both root and crown components;
mapping said landmarks on the edge of said crown component on to said generic digital tooth model;
solving a first morphing function to fix landmarks on edge of crown component to a ring-edge space;
solving a second morphing function to fix landmarks on said generic digital tooth model to ring-edge space; and
selecting vertexes in ring-edge space to stitch tooth crown with morphed template root.

2. The computer-implemented method according to claim 1, wherein generating landmarks on an edge of said crown component comprises:
defining an edge of crown component using a closed curve;
dividing the closed curve into several equal parts over its length with split points;
calculating a middle point of the closed curve;
calculating a rotation vector of the middle point; and
modifying each split point into modified split points,
wherein each original and modified split point becomes a landmark of a first and second series after projecting to an edge of the crown component.

3. The computer-implemented method according to claim 1, wherein generating landmarks on an edge of said crown component comprises determining a center of mass point for apex ends of the generic digital tooth model and determining an offset distance from the center of mass point and the apex ends.

4. The computer-implemented method according to claim 3, wherein generating landmarks on an edge of said crown component comprises determining a predicted center of mass point for apex ends of the crown component.

5. The computer-implemented method according to claim 4, wherein determining the predicted center of mass point comprises defining the predicted center of mass point as coordinates [0, 0, −RootLength], where RootLength is a predefined constant for each class of orthodontic tooth.

6. The computer-implemented method according to claim 4, wherein determining the predicted center of mass point comprises defining the predicted center of mass point as coordinates [x, y, −RootLength], where RootLength is a predefined constant for each class of orthodontic tooth.

7. The computer-implemented method according to claim 4, comprising transforming the offset distance of apex ends of the generic digital tooth model into the tooth crown coordinate system to determine a predicted location of apex ends on the crown component having the same offset distance from the predicted center of mass point.

8. A computerized system for modeling realistic looking tooth roots of a patient to facilitate dental and/or orthodontic treatment, said computerized system comprising:
a microprocessor; and
a memory device,
said microprocessor configured to:
generate a patient digital tooth model including a crown component;
generate landmarks on an edge of said crown component;
generate a generic digital tooth model corresponding to said patient digital tooth model, said generic digital tooth model including both root and crown components;
map said landmarks on the edge of said crown component on to said generic digital tooth model;
solve a firsts morphing function to fix landmarks on edge of crown component to a ring-edge space;
solve a second morphing function to fix landmarks on said generic digital tooth model to ring-edge space; and
select vertexes in ring-edge space to stitch tooth crown with morphed template root.

9. The system according to claim 8, wherein to generate landmarks on the edge of said crown component said microprocessor is further configured to:
define an edge of crown component using a closed curve;
divide the closed curve into several equal parts over its length with split points;
calculate a middle point of the closed curve;
calculate a rotation vector of the middle point; and
modify each split point into modified split points,
wherein each original and modified split point becomes a landmark of a first and second series after projecting to an edge of the crown component.

10. The system according to claim 8, wherein to generate landmarks on the edge of said crown component, said microprocessor is further configured to determine a center of mass point for apex ends of the generic digital tooth model and determining an offset distance from the center of mass point and the apex ends.

11. The system according to claim 10, wherein to generate landmarks on an edge of said crown component, said microprocessor is further configured to determine a predicted center of mass point for apex ends of the crown component.

12. The system according to claim 11, wherein to determine the predicted center of mass point, said microprocessor is further configured to define the predicted center of mass point as coordinates [0, 0, −RootLength], where RootLength is a predefined constant for each class of orthodontic tooth.

13. The system according to claim 11, wherein to determine the predicted center of mass point, said microprocessor is further configured to define the predicted center of mass point as coordinates [x, y, −RootLength], where RootLength is a predefined constant for each class of orthodontic tooth.

14. The system according to claim 11, wherein said microprocessor is further configured to transform the offset distance of apex ends of the generic digital tooth model into the tooth crown coordinate system to determine a predicted location of apex ends on the crown component having the same offset distance from the predicted center of mass point.
